(19) United States
(12) Patent Application Publication
(10) Pub. No.: US 2005/0220576 A1
(43) Pub. Date: Oct. 6, 2005

(54) Substrate manufacturing apparatus and substrate transfer module used therein

(75) Inventors: Ki-Sang Kim, Yongin-si (KR); Seung-Ki Chae, Seoul (KR); Yun-Sik Yang, Suwon-si (KR); Seong-Hun Jeon, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 10/990,249

(22) Filed: Nov. 16, 2004

(30) Foreign Application Priority Data
Jan. 7, 2004 (KR) 2004-00976

(51) Int. Cl. B65G 1/00

(52) U.S. Cl. 414/217

(57) ABSTRACT

A substrate manufacturing apparatus comprises a transfer chamber, at least one process chamber disposed adjacent to a lateral face of the transfer chamber, and a substrate transfer module including at least two transfer robots which transfer a substrate to the process chamber, the substrate transfer module being disposed at the transfer chamber. Each of the at least two transfer robots comprises a blade including at least two supporters for supporting a substrate, an arm part connected to the blade to move the blade, and an arm driving part for driving the blade and the arm part.

### CROSS-REFERENCE TO RELATED APPLICATION

This application claims priority to Korean Patent Application No. 2004-00976, filed on Jan. 7, 2004 in the Korean Intellectual Property Office, the disclosure of which is incorporated herein in its entirety by reference.

### TECHNICAL FIELD

The present invention relates to an apparatus for manufacturing semiconductor substrates and, more particularly, to a substrate manufacturing apparatus including a substrate transfer module for transferring substrates to process chambers.

### BACKGROUND

Processes such as deposition or etching are carried out to fabricate semiconductor devices on a semiconductor wafer. Recently, a cluster system has been used to enhance efficiency of semiconductor fabricating process. In conventional cluster system, a polygonal transfer chamber is disposed in the center of the cluster system. A plurality of process chambers are disposed around the polygonal transfer chamber.

A transfer chamber of a conventional cluster system is quadrangular or pentagonal. A transfer robot is installed in the center of the conventional cluster system. A loadlock chamber is disposed at one side of the transfer chamber. A process chamber is disposed at least one of the other sides of the transfer chamber. One or more process chambers are disposed abreast at the side of the transfer chamber. When two process chambers are disposed, each of the process chambers has one substrate stage. When one process chamber is disposed, the process chamber has two substrate stages to perform a process for two substrates. The former is typically used when a precise regulation is required such as an etching process. The latter is typically used when a high precision is not required such as an ashing process.

A conventional cluster system is illustrated in FIG. 1 and FIG. 2. One transfer robot 980 is disposed at a transfer chamber 920. The transfer robot 980 includes a blade 982 on which a wafer is to be placed and a plurality of arms 984 connected to the blade 982. Further, the transfer robot 980 includes a driving motor. The blade 982 and the arms 984 connected thereto with one degree of freedom, i.e., moving left and right. The blade 982 includes a substrate supporter on which a wafer is to be placed. The substrate supporter is disposed at one end of the blade 982. The arm 984 is connected to the other end of the blade 982. When a particular process for a wafer is completed in a process chamber 960, the transfer robot 980 unloads the wafer from the process chamber 960 and transfers the wafer to a loadlock chamber 940.

After unloading another wafer from the loadlock chamber 940, the transfer robot 980 transfers the another wafer to the process chamber 960. These operations are repeated. A process cannot be performed during the loading, unloading, and transferring operations. Thus, an operating ratio of the cluster system is low. In a conventional cluster system, while a number of process chambers 960 are disposed, the transfer robot 980 can transfer only one wafer at a time. Therefore, the process using the conventional cluster system may not be efficient.

To enhance an operating ratio of the process chamber 960, two blades 982′ may be fixedly mounted on an arm 984, as shown in FIG. 2. In this case, two wafers can be transferred at a time to two process chambers 960 disposed abreast.

### SUMMARY OF THE INVENTION

When one of the process chambers is broken or is in preventive maintenance (PM), a process cannot be performed in the other process chamber as well. As a result, an operating ratio of the two blade system still needs to be improved.

In one exemplary embodiment of the present invention, a substrate manufacturing apparatus comprises a transfer chamber, at least one process chamber disposed adjacent to a lateral face of the transfer chamber, and a substrate transfer module including at least two transfer robots which transfer a substrate to the process chamber, the substrate transfer module being disposed at the transfer chamber. Each of the at least two transfer robots comprises a blade including at least two supporters for supporting a substrate, an arm part connected to the blade to move the blade, and an arm driving part for driving the blade and the arm part.

According to another exemplary embodiment of the present invention, a substrate manufacturing apparatus comprises a transfer chamber, a loadlock chamber disposed adjacent to one lateral face of the transfer chamber, at least one process chamber disposed adjacent to one or more of the other lateral faces of the transfer chamber, and a substrate transfer module having a revolving body and at least two transfer robots which are connected to the revolving body and to transfer a substrate between the at least one process chamber or between the at least one process chamber and the loadlock chamber. Each of the transfer robots comprises a blade including supporters each being disposed at ends of the blade to support a substrate, a first arm connected to the center of the blade, and a second arm combined with the revolving body and connected to the first arm.

According to yet another exemplary embodiment of the present invention, a substrate transfer module comprises a revolving body, and at least two transfer robots disposed at the revolving body, the at least two transfer robots being rotatable with the revolving body. Each of the transfer robots comprises a blade including at least two supporters for supporting a substrate, at least one arm part connected to the blade to move the blade, and an arm driving part for independently driving the at least one arm and the blade.

These and other exemplary embodiments, features and advantages of the present invention will become more apparent by describing in detail exemplary embodiments thereof with reference to the attached drawings.

### BRIEF DESCRIPTION OF THE DRAWINGS

FIG. 1 shows a conventional substrate manufacturing apparatus including a transfer robot.

FIG. 2 shows a conventional substrate manufacturing apparatus including another transfer robot.

FIG. 3 shows a substrate manufacturing apparatus according to an exemplary embodiment of the present invention.

FIG. 4 shows a substrate manufacturing apparatus according to another exemplary embodiment of the present invention.

FIG. 5 is a top plan view of a substrate transfer module shown in FIG. 3.

FIG. 6 is a front view of the substrate transfer module shown in FIG. 5.

FIG. 7 is a cross-sectional view of the substrate transfer module shown in FIG. 6.

FIG. 8A through FIG. 8E show an operation procedure of the substrate transfer module according to an exemplary embodiment of the present invention.

FIG. 9A through FIG. 9E show an operation procedure of the substrate transfer module according to another exemplary embodiment of the present invention.

FIG. 10A through FIG. 10E show an operation procedure of the substrate transfer module according to still another exemplary embodiment of the present invention.

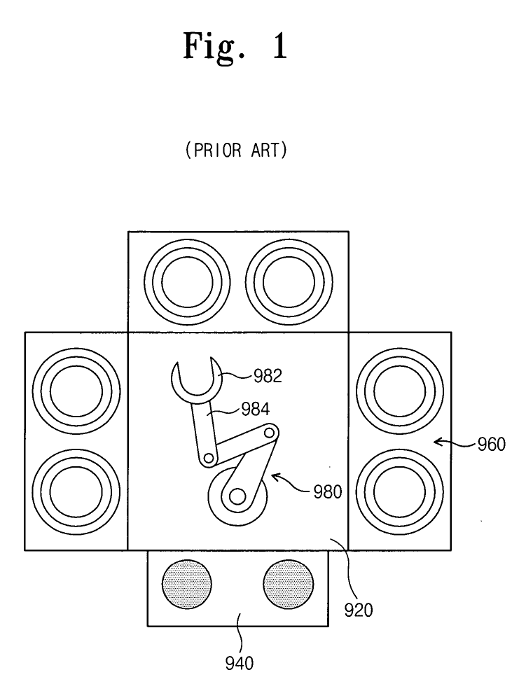

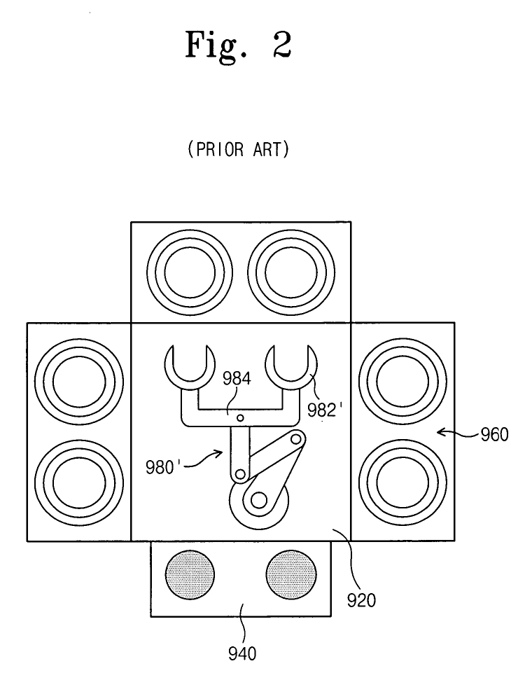

### DETAILED DESCRIPTION OF EXEMPLARY EMBODIMENTS

Exemplary embodiments of the present invention will now be described more fully with reference to the accompanying drawings. This invention may, however, be embodied in many different forms and should not be construed as being limited to the embodiments set forth herein. Rather, these embodiments are provided so that this disclosure will be through and complete, and will fully convey the concept of the invention to those skilled in the art.

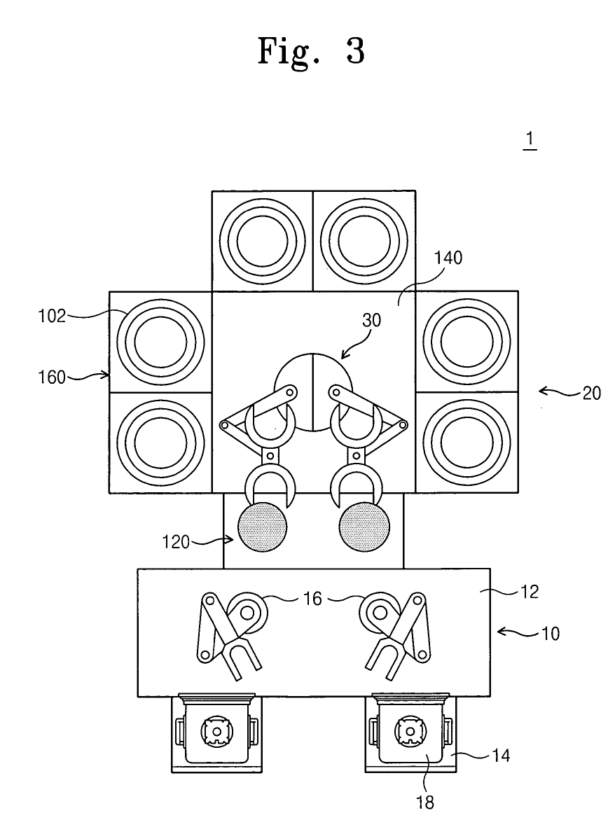

FIG. 3 illustrates a substrate manufacturing apparatus 1 according to an exemplary embodiment of the present invention. With recent trend toward large diameter wafers having, for example, 200 mm diameter through 300 mm diameter, the substrate manufacturing apparatus 1 performs in an automated process. An equipment front end module (EFEM) 10 is mounted at a process facility 20. The EFEM 10 is a kind of a wafer handling system and includes a load station 14 on which a substrate storing receptacle such as a front open unified pod (FOUP) 18 is placed. A door opener (not shown) for opening and closing a door of the FOUP 18 is mounted in a frame 12. Further, a transfer robot 16 is disposed in the frame 12 to transfer a wafer between the FOUP 18 and the process facility 20.

The process facility 20 is to perform one or more processes for a wafer and includes a loadlock chamber 120, a transfer chamber 140, process chambers 160, and a substrate transfer module 30. The transfer chamber 140 is a polygonal chamber, which is disposed in the center of the process facility 20. The loadlock chamber 120 is disposed between the EFEM 10 and the transfer chamber 140. Wafers to be processed are placed in the loadlock chamber 120. A plurality of process chambers 160 are disposed abreast at each lateral face of the transfer chamber 140 to perform a particular process for a wafer. The same process can be carried out in the process chambers 160 disposed abreast.

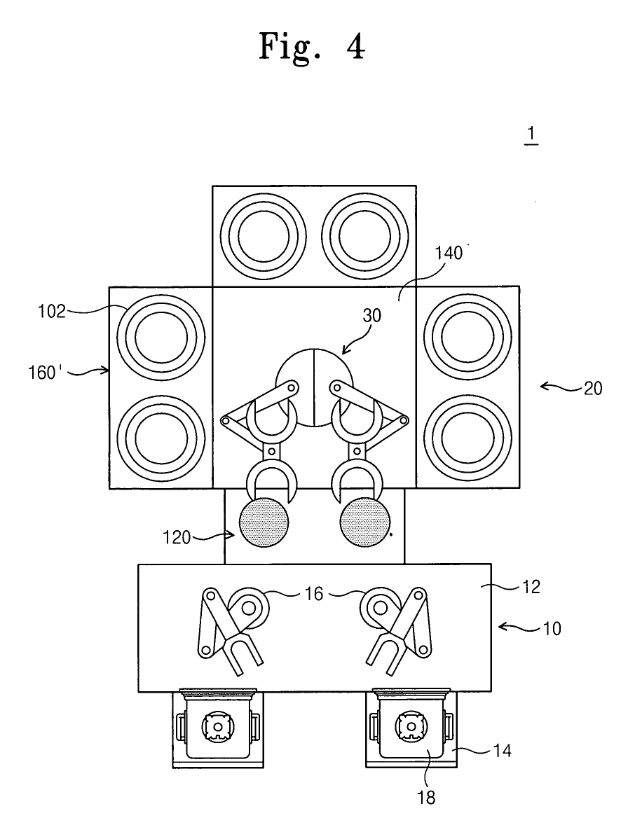

In an exemplary embodiment of the present invention, two of the process chambers 160 are disposed abreast. A substrate stage 102 is disposed each of the process chambers 160. In another exemplary embodiment of the present invention, as shown in FIG. 4, a process chamber 160′ is disposed at each lateral faces of a transfer chamber 140 and two or more substrate stages are disposed abreast in a process chamber 160′ to perform a process for two wafers at a time. For example, an etching process may be performed for one wafer in each of the process chambers 160 because conditions of the etching process needs to be regulated precisely. On the other hand, an ashing process may be performed for a plurality of wafers in one process chamber 160′ because conditions of the ashing process need not be regulated precisely.

When a tetragonal transfer chamber 140 is used, a loadlock chamber 120 may be disposed at one lateral face of the transfer chamber 140. The above-described process chambers may be disposed at the other three lateral faces thereof. The process chambers 160 may be chambers in which the same process can be performed. Alternatively, different processes may be performed to sequentially perform a series of processes for one wafer. The substrate transfer module 30 can be disposed in the center of the transfer chamber 140 to transfer a wafer between the loadlock chamber 120 and the process chamber 160 or between adjacent process chambers 160.

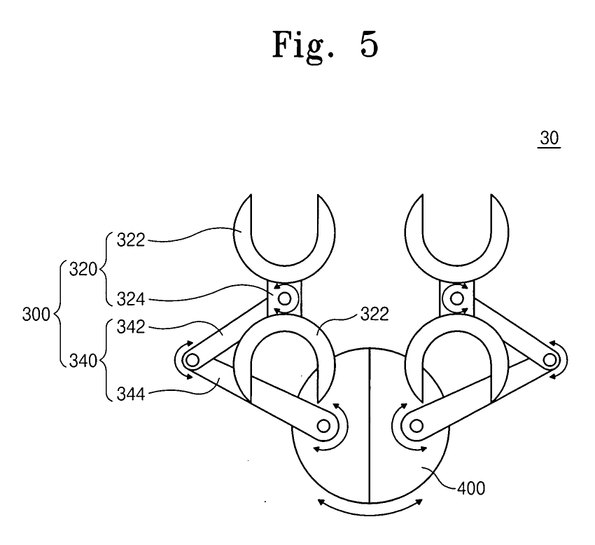

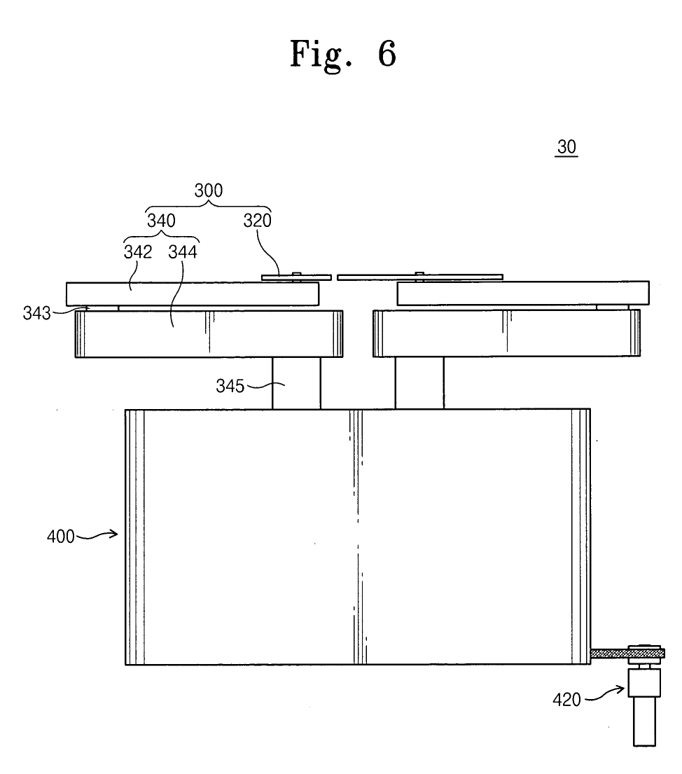

Referring to FIG. 5 and FIG. 6, the substrate transfer module 30 includes a revolving body 400, a revolving body driving part 420, and a plurality of transfer robots 300. The plurality of transfer robots 300 can move independent of the revolving body 400. In exemplary embodiments of the present invention, two transfer robots 300 are disposed. The revolving body 400 is disposed in the center of the transfer chamber 140 and has a cylindrical shape. The revolving body 400 may revolve on its axis. Each of the transfer robots 300 includes a blade 320 and an arm part 340 for moving the blade 320. The blade 320 includes a bar-type connector 324 and C-shaped supporters 322. The C-shaped supporters are disposed at both ends of the connector 324. Each of the supporters 322 supports the bottom of a wafer. Specifically, each of the supporters 322 may adsorb a wafer in vacuum state or may mechanically support a wafer.

The arm part 340 is composed of an upper arm 342 and a lower arm 344. One end of the upper arm 342 is connected to the center of the connector 324. One end of the lower arm 344 is connected to the other end of the upper arm 342. The other end of the lower arm 344 is connected to the revolving body 400. The blade 320 may rotate relative to the upper arm 342. The upper arm 342 may rotate relative to the lower arm 344. Further, the lower arm 344 may rotate relative to the revolving body 400.

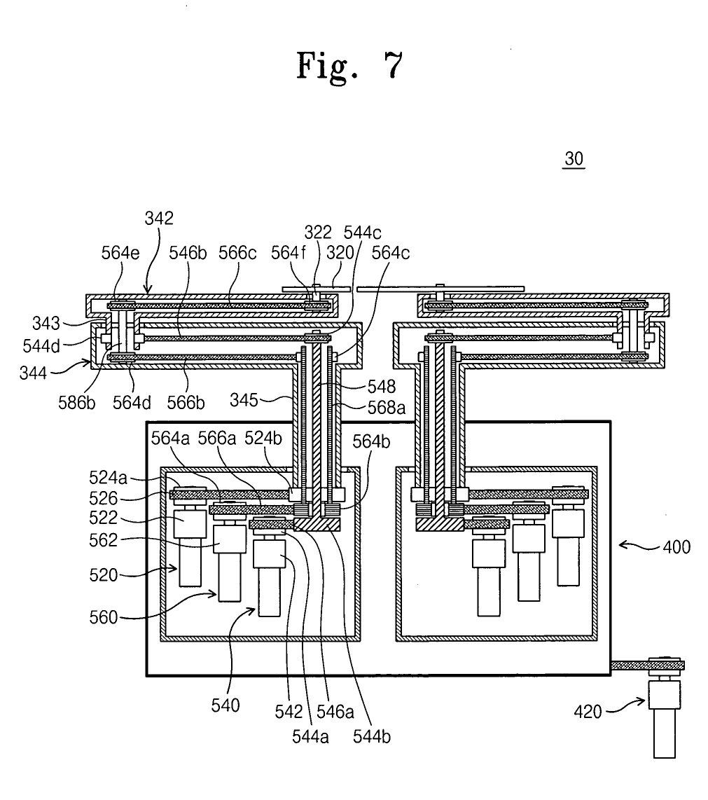

FIG. 7 shows an arm driving part according to an exemplary embodiment of the present invention. The arm driving part rotates the blade 320, the upper arm 342, and the lower arm 344. The arm driving part has a lower arm driving part 520, an upper arm driving part 540, and a blade driving part 560. A lower arm connecting axis 345 is vertically extended from one end of the lower arm 344 to be connected to the revolving body 400. The lower arm driving part 520 enables the lower arm 344 to rotate on the connecting axis 345 in the revolving part 400. The lower arm driving part 520 includes a driving motor 522 inserted into the revolving body 400, a first lower pulley 524a, a second lower pulley 524b, and a lower belt 526. The first lower pulley 524a is connected to the driving motor 522 to be rotated. The second lower pulley 524b is disposed at one end of the lower arm connecting axis 345. The second lower pulley 524b may be constructed monolithically with the lower arm connecting axis 345.

Alternatively, the second lower pulley 524b and lower arm connecting axis 345 may be combined with each other after they are separately manufactured. The lower belt 526 is connected to the first lower pulley 524a and the second lower pulley 524b to transfer rotatory power of the driving motor 522 to the lower arm connecting axis 345.

The upper arm connecting axis 343 is vertically extended from one end of the upper arm 342 to be connected to the lower arm 344. The upper arm driving part 540 includes a driving motor 542, a first upper pulley 544a, a second upper pulley 544b, a first upper belt 546a, a third upper pulley 544c, a fourth upper pulley 544d, a second upper belt 546b, and a first rotation axis 548. The first upper pulley 544a is connected to the driving motor 542 to be rotated. The first rotation axis 548 is inserted into the lower arm connecting axis 345. The second upper pulley 544b is connected to one end of the first rotation axis 548. The third upper pulley 544c is connected to the other end of the first rotation axis 548. The first upper belt 546a is connected to the first upper pulley 544a and the second upper pulley 544b to transfer rotatory power of the driving motor 542 to the first rotation axis 548. The fourth upper pulley 544d is disposed one end of the upper arm connecting axis 343. The fourth upper pulley 544d may be constructed monolithically with the upper arm connecting axis 343.

Alternatively, the fourth upper pulley 544d and the upper arm connecting axis 343 may be combined with each other after they are separately manufactured. The second upper belt 546b transfers rotatory power of the first rotation axis 548 to the upper arm connecting axis 343.

A blade connecting axis 322 is a rod-type axis. One end of the blade connecting axis 326 is fixed to the center of the connector 324 shown in FIG. 5 of the blade 320. The other end thereof is connected to the upper arm 342. The blade driving part 560 enables the blade 320 to rotate on the blade connecting axis 326 in the upper arm 342. The blade driving part 560 includes a driving motor 562, a first blade pulley 564a, a second blade pulley 564b, a first blade belt 566a, a third blade pulley 564c, a fourth blade pulley 564d, a second blade belt 566b, a fifth blade pulley 564e, a sixth blade pulley 564f, a third blade belt 566c, a second rotation axis 568a, and a third rotation axis 568b.

The first blade pulley 564a is connected to the driving motor 562 to be rotated thereby. The second rotation axis 568a is inserted into the lower arm connecting axis 345 to insert the first rotation axis 548. The second blade pulley 564 is connected to one end of a second rotation axis 569a. The third plate pulley 564c is connected to the other end of the second rotation axis. The first blade belt 566a is connected to the first blade pulley 564a and the second blade pulley 564b to transfer rotatory power of the driving motor 562 to the second rotation axis 568a. The third rotation axis 568b is inserted into the upper arm connecting axis 343. The fourth blade pulley 564d is connected to one end of the third rotation axis 343. The fifth blade pulley 564e is connected to the other end of the third rotation axis 343.

The second blade belt 566b is connected to the third blade pulley 564c and the fourth blade pulley 564d to transfer rotatory power of the second rotation axis 568a to the third rotation axis 568c. The sixth blade pulley 564f is connected to the blade connecting axis 326. The third blade belt 566c transfers rotatory power of the third rotation axis 526c to the blade connecting axis 326. Due to the above-described structure of the arm driving part, the blade 320, the upper arm 342, and the lower arm 344 may operate independently.

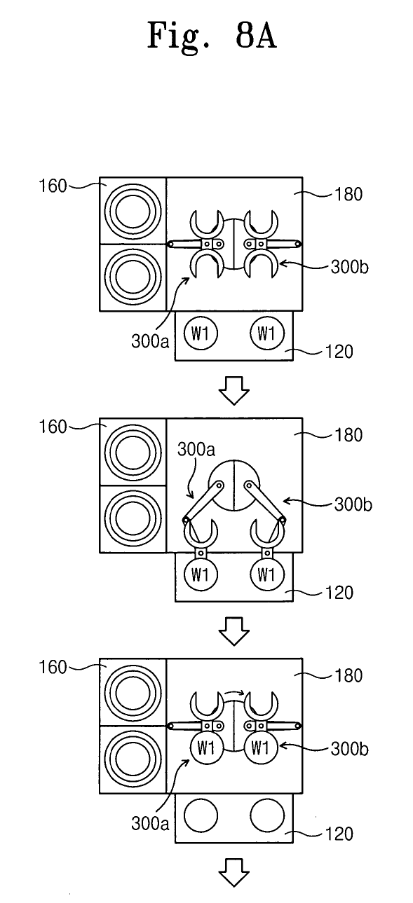

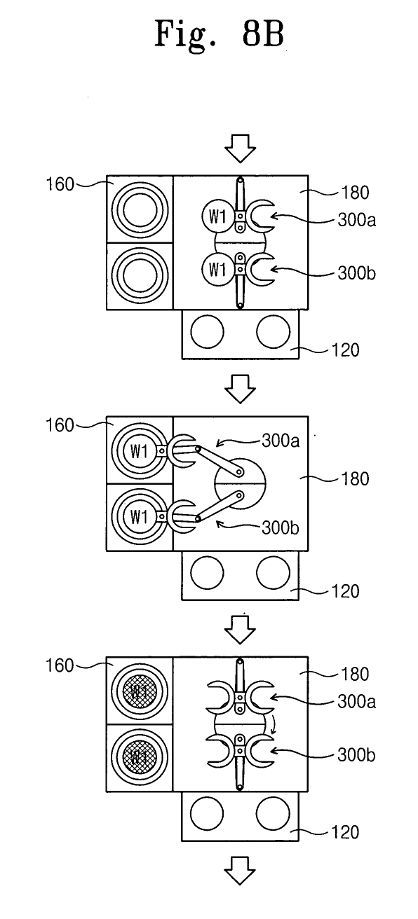

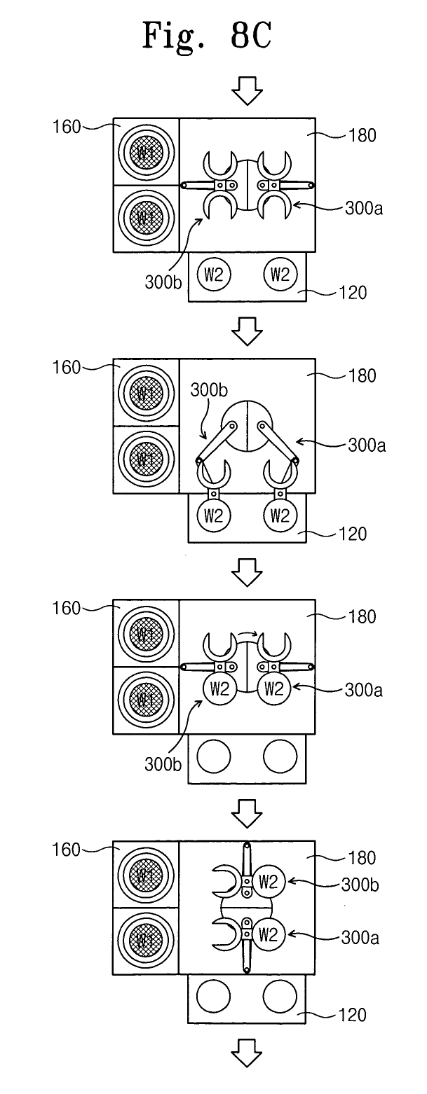

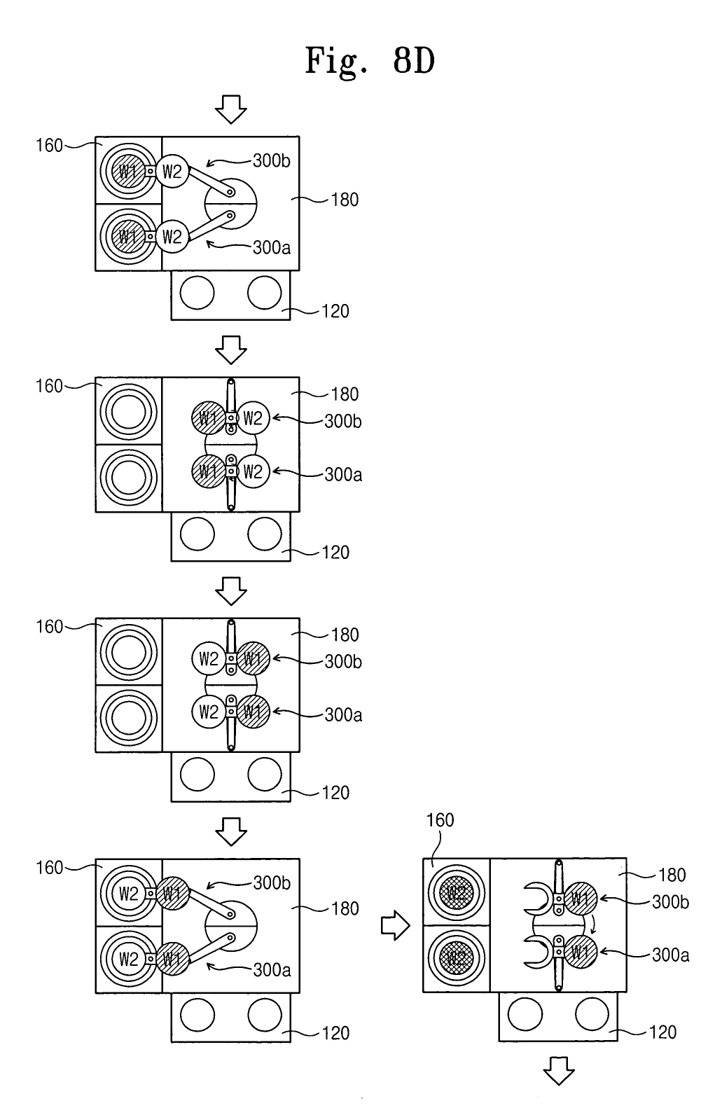

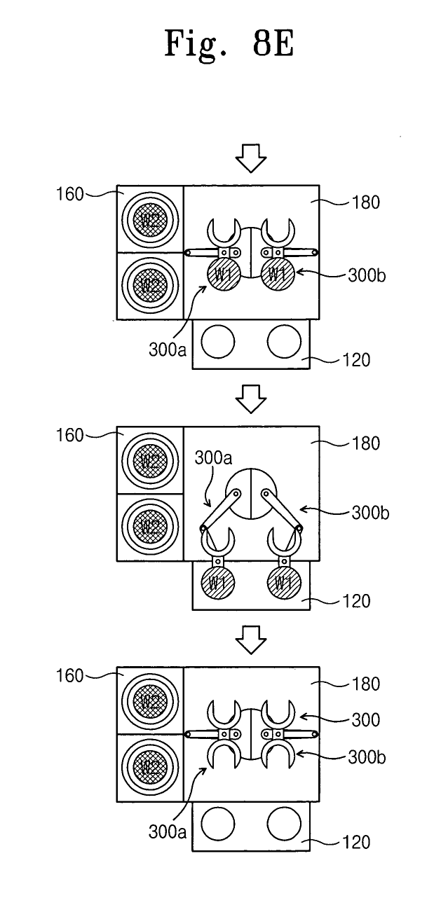

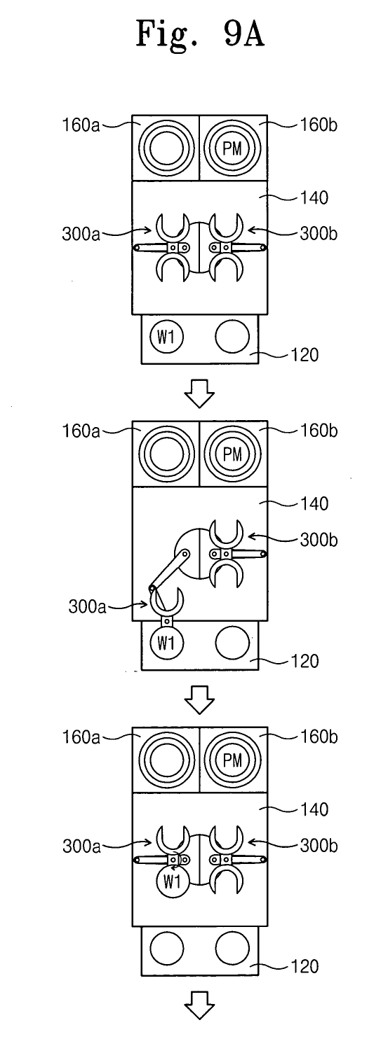

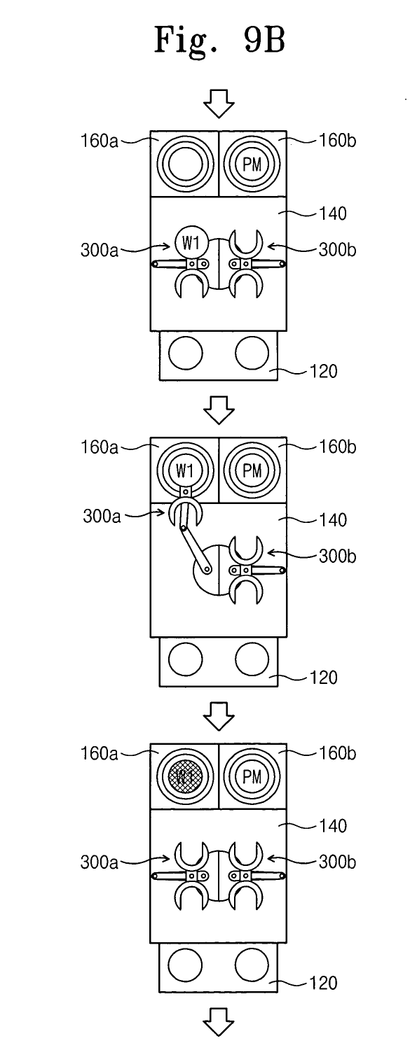

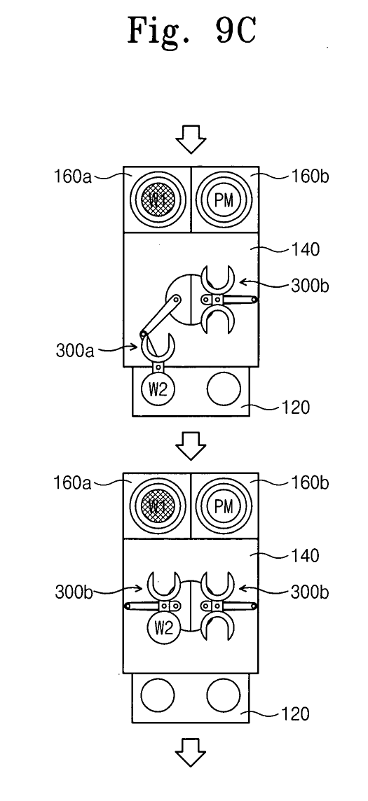

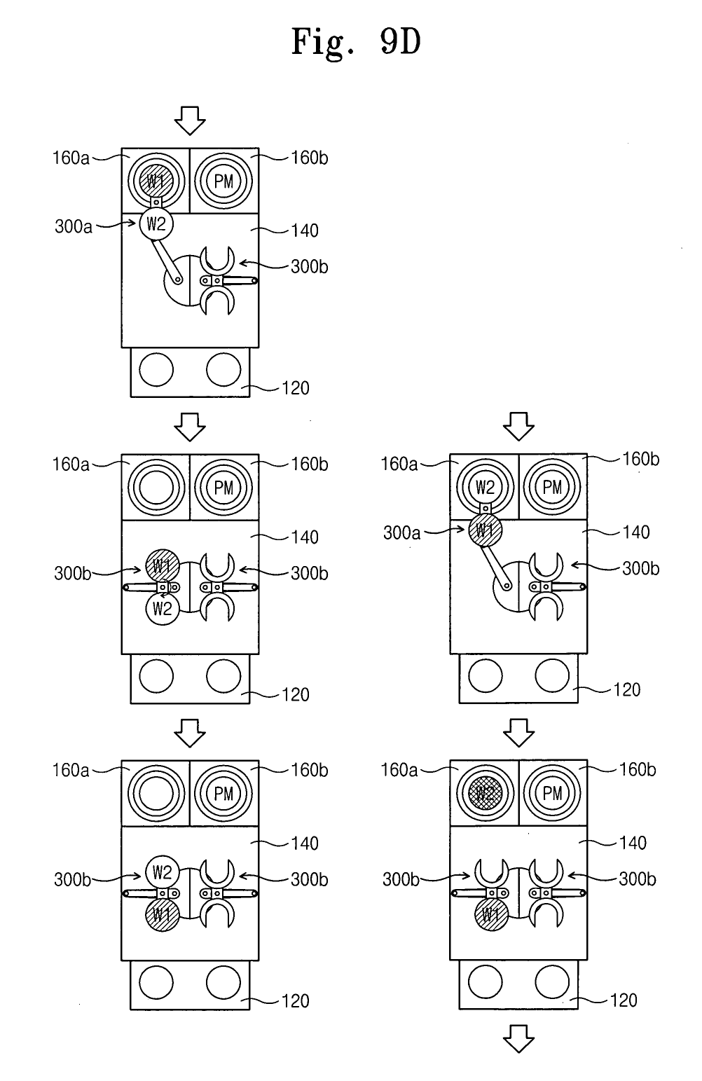

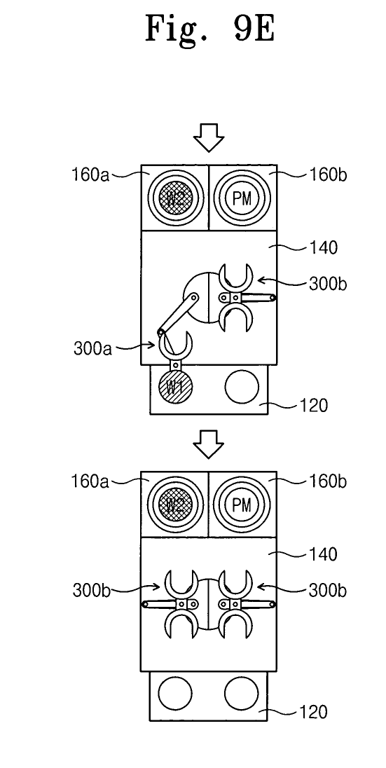

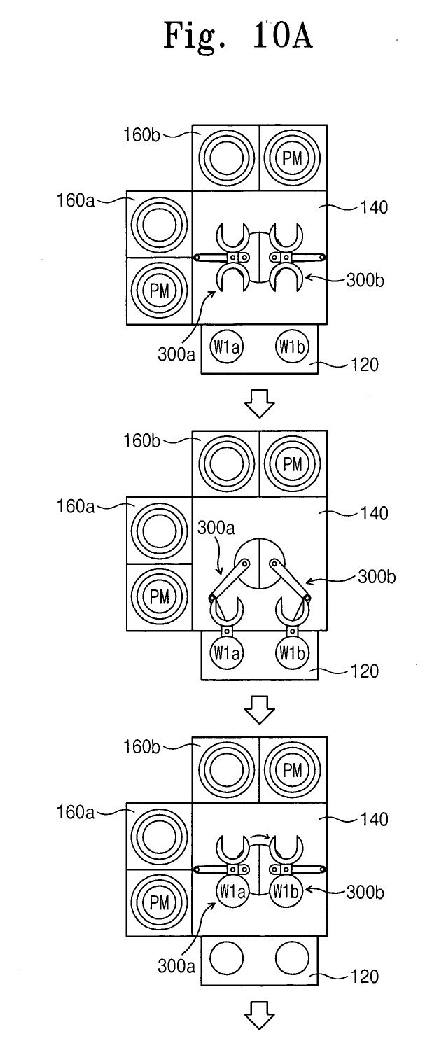

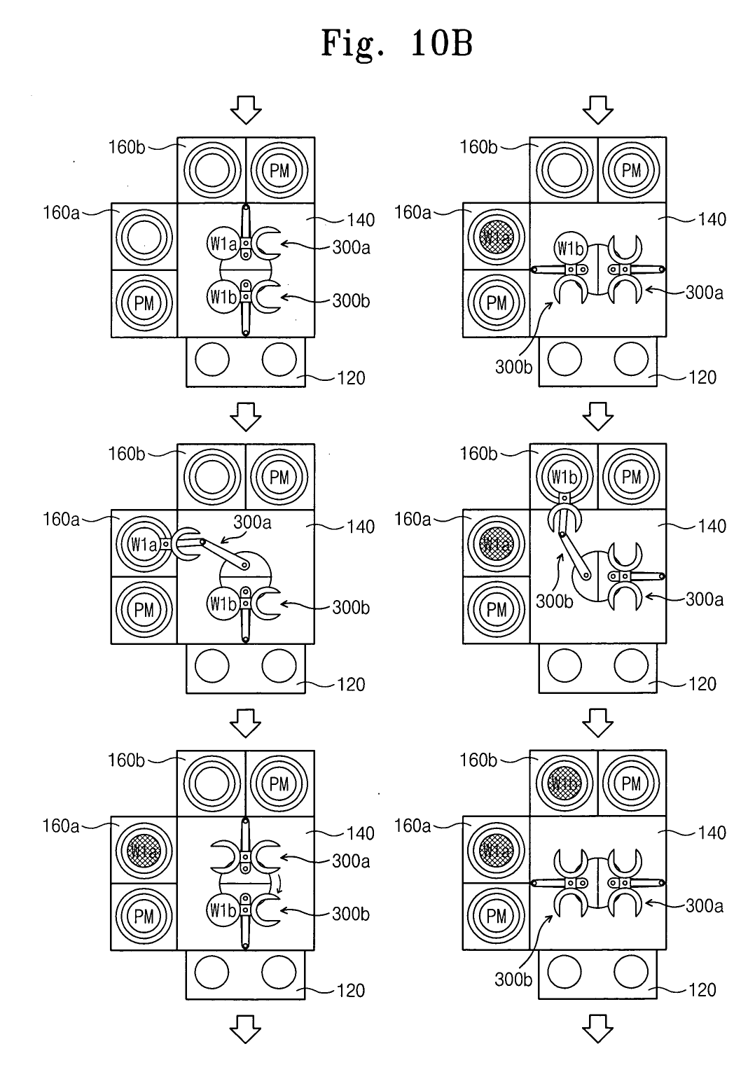

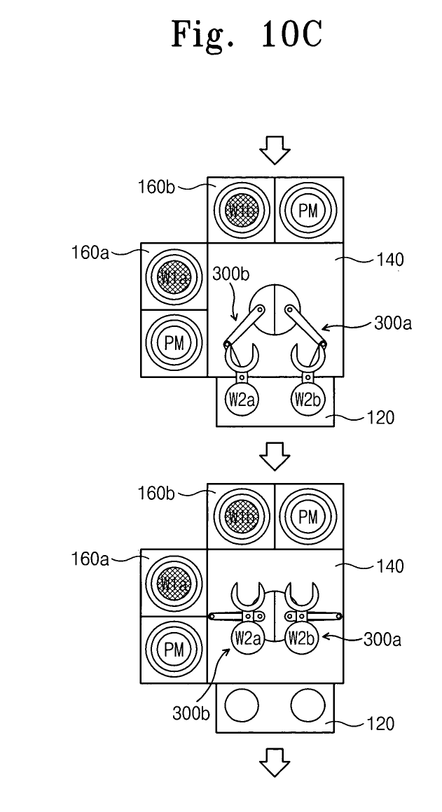

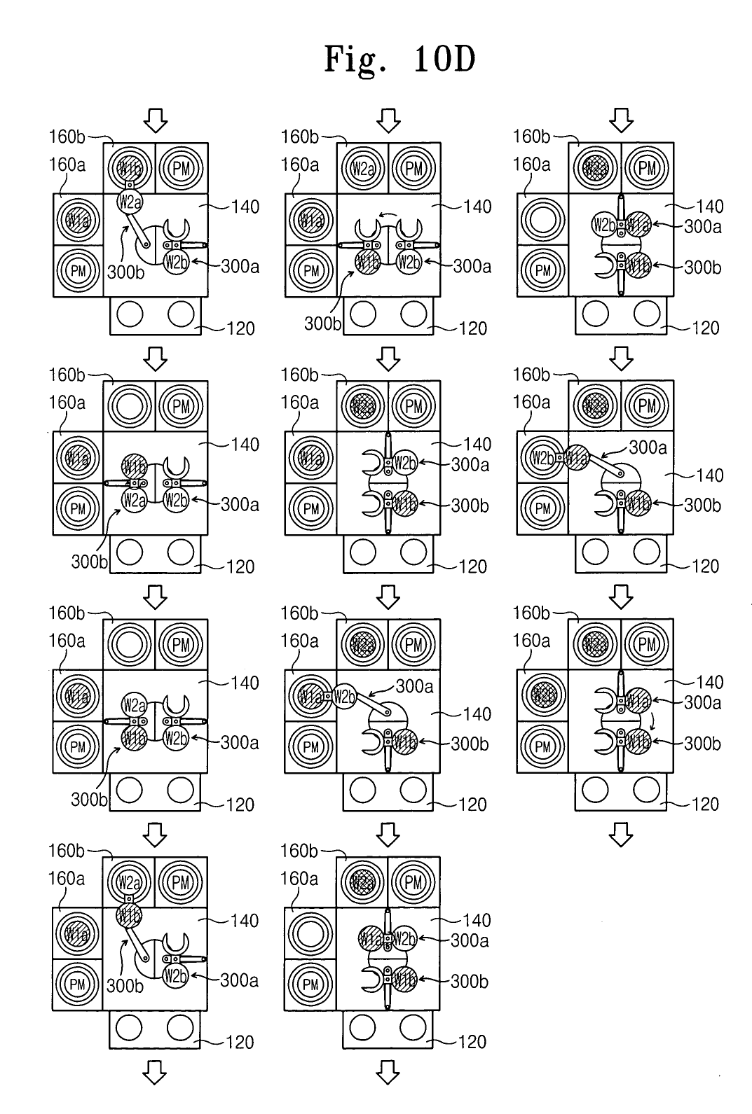

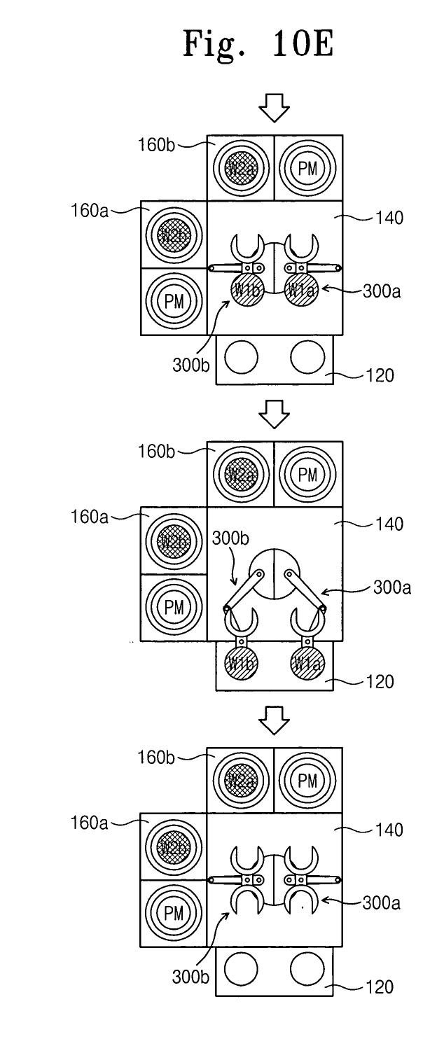

Exemplary embodiments of the present invention using the above-described substrate transfer module 30 will now be described with reference to FIG. 8 through FIG. 10. FIG. 8A through FIG. 8E illustrate a wafer transfer procedure when two of the process chambers 160 can be used. FIG. 9A through FIG. 9E illustrate a wafer transfer procedure when one of the process chambers 160 can be used. FIG. 10A through FIG. 10E illustrate a wafer transfer procedure when two of the process chambers 160 are disposed adjacent to two lateral faces of a transfer chamber 140.

Referring to FIG. 8A through 8E, a transfer chamber 180 is a tetragonal chamber. A loadlock chamber 120 is disposed at one lateral face of the transfer chamber 180. The process chambers 160 performing the same process are disposed abreast at one of the other lateral faces of the transfer chamber 180. A circle having an empty inside represents a wafer whose process is not performed yet. A circle having the inside drawn as an oblique line represents a wafer whose process is completed.

Referring to FIG. 8A, wafers W1 are unloaded from a loadlock chamber 120 to a first transfer robot 300a and a second transfer robot 300b, respectively. A revolving body 400 makes a 90-degree revolution toward the process chambers 160. Referring to FIG. 8B, the transfer robots 300a and 300b load a wafer W1 to the process chamber 160 at the same time. While the process is performed in the process chambers 160, the revolving body 400 makes a 90-degree revolution such that a blade 320 faces a loadlock chamber 120.

Referring to FIG. 8C, when next process is performed, wafers W2 are unloaded from the loadlock chamber 120 to the transfer robots 300a and 300b. For the blade 320 of the respective transfer robots 300a and 300b, a wafer W2 in which a process is to be performed is placed on one supporter while another supporter is kept in an empty state. The revolving body 400 revolves such that an empty supporter faces the process chambers 160. The transfer robots 300a and 300b wait until the process is completed. When the process chambers 160 performing the same process are disposed at another lateral face of the transfer chamber 140, the transfer robots 300a and 300b perform an operation of FIG. 8C after loading wafers to the process chambers 160.

Referring to FIG. 8D, if the process is completed in the process chambers 160, the transfer robots 300a and 300b unload the wafer W1 from the process chambers 160 onto an empty supporter of the blade 320. The revolving body 400 makes a 180-degree revolution such that the waiting wafer W2 faces the process chambers 160. The transfer robots 300a and 300b load waiting wafers W2 to the process chambers 160. Alternatively, relocation of the blade 320 may be done not by rotating the revolving body 400 but by making a 180-degree rotation of the blade 320 from the upper arm 342.

Referring to FIG. 8E, the transfer robots 300a and 300b load the wafer W1 placed on the supporter of the blade 320 to the loadlock chamber 120. Afterwards, the above-mentioned steps are repeated until the process is completed for all wafers W in the loadlock chamber 120.

Referring to FIG. 9A through FIG. 9E, one of process chambers 160a and 160b is broken or maintained. A process can be performed only in one of the process chambers 160a or 160b. Thus, only one transfer robot 300a operates and the other transfer robot 300b is maintained in a pause state.

Referring to FIG. 9A, a wafer W1 is unloaded from the loadlock chamber 120 to the first transfer robot 300a. The blade 320 makes a 180-degree rotation on an upper arm 342 to face a process chamber 160a.

Referring to FIG. 9B, the first transfer robot 300a loads the wafer W1 to the process chamber 160a. Referring to FIG. 9C, while a process is performed in the process chamber 160a, a wafer W2 in which a process is to be performed next is unloaded from the loadlock chamber 120 to a supporter of the blade 320 and waits until the process is completed in the process chamber 160a.

Referring to FIG. 9D, when the process is completed in the process chamber 160a, the wafer W1 is unloaded from the process chamber 160a onto an empty supporter of the blade 320. The blade 320 makes a 180-degree rotation on the upper arm 342 such that the waiting wafer W2 faces the process chamber 160a. The first transfer robot 300a loads the wafer W2 placed on the supporter of the blade 320 to the process chamber 160a. Referring to FIG. 9E, the processed wafer W1 placed on the blade 320 is loaded onto the loadlock chamber 120. Afterwards, the above-mentioned steps are repeated.

When a process is performed using only one transfer robot 300a, it is preferable that the blade 320 rotates relative to the upper arm 342 instead of revolution of the revolving body 400. Power may be consumed less when the blade 320 revolves than when the revolving body 400 revolves. Time for rotation operation can be shortened, thus enhancing an operation rate of equipment.

In FIG. 10A through FIG. 10E, two of the process chambers 160 are disposed adjacent to two lateral faces of the transfer chamber 140. A process can be performed in only one of the process chambers 160 disposed abreast. An exemplary embodiment of the present invention using the operating procedure of a substrate transfer module 30 will now be described.

Referring to FIG. 10A, wafers W1a and W1b are unloaded from a loadlock chamber 120 to a first transfer robot 300a and a second transfer robot 300b, respectively. A revolving body 400 rotates such that a blade of the first transfer robot 300a faces a first process chamber 160a.

Referring to FIG. 10B, the first transfer robot 300a loads the wafer W1a to the first process chamber 160a. The revolving body 400 rotates such that a blade of the second transfer robot 300b faces a second process chamber 160b. The second transfer robot 300b loads the wafer W1b to the second process chamber 160b. A process is performed from the process chambers 160a and 160b.

Referring to FIG. 10C, the first transfer robot 300a and the second transfer robot 300b unload wafers W2a and W2b from the loadlock chamber 120 and wait until the process is completed in the process chambers 160a and 160b.

Referring to FIG. 10D, when the process is completed, the second transfer robot 300b unloads the processed wafer W1b from the second process chamber 160b to an empty one of the supporters of the blade 320. The blade 320 of the second transfer robot 300b makes a 180-degree rotation from an upper arm 342 such that a waiting wafer W2a faces the second process chamber 160b. The second transfer robot 300b loads the waiting wafer W2a to the second process chamber 160b. The revolving body 400 revolves. The first transfer robot 300b unloads the processed wafer W1b from the first process chamber 160a to an empty one of the supporters of the blade 320. The blade of the first transfer robot 300a makes a 180-degree rotation from the upper arm 342 such that a waiting wafer W2b faces the first process chamber 160a. The first transfer robot 300a loads the waiting wafer W2b to the first transfer chamber 160a.

Referring to FIG. 10E, the revolving body 400 rotates such that the supporter supporting the wafers W1a and W1b faces the loadlock chamber. The transfer robots 300a and 300b loads the processed wafers W1a and W1b to the loadlock chamber 120. The above-described steps of FIG. 10A through FIG. 10E maybe repeated until a process is performed for all wafers W in the loadlock chamber 120.

As explained above, a substrate transfer module disposed at a transfer chamber has two substrate transfer robots which can operate independently. When one of two process chambers disposed abreast is broken or maintained, a wafer can be transferred to the other process chamber. Thus, an operation rate of equipment can be enhanced. Since a blade can be independently rotatable relative to an upper arm, power consumption and time required for rotation operation can be reduced compared when a revolving body revolves. One blade may have two supporters. A wafer in which the next process is to be performed waits in advance while the process is performed in the process equipment. Therefore, time required for transferring wafers can be shortened.

Although exemplary embodiments have been described herein with reference to the accompanying drawings, it is to be understood that he present invention is not limited to those precise embodiments, and that various other changes and modifications may be affected therein by one ordinary skill in the related art without departing from the scope of spirit of the invention.

1. A substrate manufacturing apparatus comprising:
a transfer chamber;
at least one process chamber disposed adjacent to a lateral face of the transfer chamber; and
a substrate transfer module including at least two transfer robots which transfer a substrate to the process chamber, the substrate transfer module being disposed at the transfer chamber,
wherein each of the at least two transfer robots comprises:
a blade including at least two supporters for supporting a substrate;
an arm part connected to the blade to move the blade; and
an arm driving part for driving the blade and the arm part.

2. The substrate manufacturing apparatus of claim 1, wherein the blade is rotatable relative to the arm part.

3. The substrate manufacturing apparatus of claim 1, further comprising:
a revolving body where the arm part of each of the transfer robots is installed; and
a revolving body driving part for rotating the revolving body.

4. The substrate manufacturing apparatus of claim 3, wherein the at least two transfer robots operate independent of the revolving body.

5. The substrate manufacturing apparatus of claim 1, wherein the blade has the two supporters which are disposed at both ends of the blade, and the arm part comprises a first arm connected to the center of the blade and a second arm connected to the first arm to be disposed there below.

6. The substrate manufacturing apparatus of claim 5, wherein the arm driving part comprises:
a blade driving part for rotating the blade on the basis of a connecting axis to which the blade and the first arm are connected;
a first arm driving part for rotating the first arm on the basis of a connecting axis to which the first arm and the second arm are connected; and
a second arm driving part for rotating the second arm independently of the first arm.

7. The substrate manufacturing apparatus of claim 6, wherein the second arm driving part includes a first lower pulley disposed in the revolving body and rotated by a driving motor, a second lower pulley disposed at one end of the connecting axis of the second arm, and a second belt connected to the first lower pulley and the second lower pulley.

8. The substrate manufacturing apparatus of claim 6, wherein the first arm driving part includes a first upper pulley disposed in the revolving body and rotated by a driving motor, a second upper pulley disposed at one end of a first rotation axis inserted into the connecting axis of the second arm, a first upper belt connected to the first upper pulley and the second upper pulley, a third upper pulley connected to the other end of the first rotation axis, a fourth upper pulley disposed at one end of the connecting axis of the second arm; and a second upper belt connected to the third upper pulley and the fourth upper pulley.

9. The substrate manufacturing apparatus of claim 6, wherein the blade driving part includes a first blade pulley disposed in the revolving body and rotated by a driving motor, a second blade pulley disposed at one end of a second rotation axis which inserts the first rotation axis therein and is disposed in the connecting axis of the first arm, a first blade belt connected to the first blade pulley and the second blade pulley, a third blade pulley connected to the other end of the second rotation axis, a fourth blade pulley disposed at one end of a third rotation axis inserted into the connecting axis of the first arm, a second blade belt connected to the third blade pulley and the fourth blade pulley, a fifth blade pulley disposed at the other end of the third rotation axis, a sixth blade pulley disposed at one end of the connecting axis of the blade, and a third blade belt for connecting the fifth blade pulley to the sixth blade pulley.

10. The substrate manufacturing apparatus of claim 1, wherein the at least one process chamber includes at least one substrate stage disposed therein.

11. The substrate manufacturing apparatus of claim 1, further comprising at least one loadlock chamber disposed at one of lateral faces of the transfer chamber, wherein transferring a substrate between the at least one process chamber and the at least one loadlock chamber is conducted by the substrate transfer module.

12. The substrate manufacturing apparatus of claim 2, wherein the blade includes the at least two supporters and while a process is performed for a substrate in one of the at least one process chamber, the at least two transfer robots wait to support a substrate, where next process is to be performed, to one of the at least two supporters.

13. The substrate manufacturing apparatus of claim 12, the transfer robot unloads a substrate, which is processed in the process chamber by an empty supporter of the at least two supporters of the blade, from the at least one process chamber and loads a substrate waiting for next process to the at least one process chamber after rotating the blade by the arm part.

14. A substrate manufacturing apparatus comprising:
a transfer chamber;
a loadlock chamber disposed adjacent to one lateral face of the transfer chamber;
at least one process chamber disposed adjacent to one or more of the other lateral faces of the transfer chamber; and
a substrate transfer module having a revolving body and at least two transfer robots which are connected to the revolving body and to transfer a substrate between the at least one process chamber or between the at least one process chamber and the loadlock chamber, wherein each of the transfer robots comprises:
a blade including supporters each being disposed at ends of the blade to support a substrate;
a first arm connected to the center of the blade; and
a second arm combined with the revolving body and connected to the first arm.

15. The substrate manufacturing apparatus of claim 14, wherein the at least two transfer robots operate independent of the revolving body.

16. The substrate manufacturing apparatus of claim 14, further comprising a blade driving part, a second arm driving part, and a first arm driving part.

17. The substrate manufacturing apparatus of claim 16, wherein the second arm driving includes a first lower pulley disposed in the revolving body and rotated by a driving motor, a second lower pulley disposed at one end of the connecting axis of the second arm, and a second belt connected to the first lower pulley and the second lower pulley.

18. The substrate manufacturing apparatus of claim 16, wherein the first arm driving part includes a first upper pulley disposed in the revolving body and rotated by a driving motor, a second upper pulley disposed at one end of a first rotation axis inserted into the connecting axis of the second arm, a first upper belt connected to the first upper pulley and the second upper pulley, a third upper pulley disposed at the other end of the first rotation axis, a fourth upper pulley disposed at one end of a connecting axis of the first arm, and a second upper belt connected to the third upper pulley and the fourth upper pulley.

19. The substrate manufacturing apparatus of claim 16, wherein the blade driving part includes a first blade pulley disposed in the revolving body and rotated by a driving motor, a second blade pulley disposed at one end of a second rotation axis which inserts the first rotation axis therein and is disposed in the connecting axis of the first arm, a first blade belt connected to the first blade pulley and the second blade pulley, a third blade pulley disposed at the other end of the second rotation axis, a fourth blade pulley disposed at one end of a first rotation axis inserted into the connecting axis of the first arm, a second blade belt connected to the third blade pulley and the fourth blade pulley, a fifth blade pulley disposed at the other end of the third rotation axis, a sixth blade pulley disposed at one end of the connecting axis of the blade, and a third blade belt for connecting the fifth blade pulley to the sixth blade pulley.

20. A substrate transfer module comprising:
a revolving body; and
at least two transfer robots disposed at the revolving body, the at least two transfer robots being rotatable with the revolving body,
wherein each of the transfer robots comprises:
a blade including at least two supporters for supporting a substrate;
at least one arm part connected to the blade to move the blade; and
an arm driving part for independently driving the at least one arm and the blade.

21. The substrate transfer module of claim 20, wherein the at least two supporters disposed at both ends of the blade, and the at least one arm part comprises a first arm connected to a center of the blade and a second arm disposed below the first arm.

22. The substrate transfer module of claim 21, wherein the arm driving part comprises:
a blade driving part for rotating the blade on the basis of a connecting axis to which the blade and the first arm are connected;
an first arm driving part for rotating the first arm on the basis of a connecting axis to which the first arm the second arm are connected; and
a second arm driving part for rotating the second arm independently of the first arm.

23. The substrate transfer module of claim 22, wherein the second arm driving includes a first lower pulley disposed in the revolving body and rotated by the driving motor, a second lower pulley disposed at one end of the connecting axis of the second arm, and a lower belt connected to the first lower pulley and the second lower pulley.

24. The substrate transfer module of claim 22, wherein the first arm driving part includes a first upper pulley disposed in the revolving body and rotated by a driving motor, a second upper pulley disposed at one end of a first rotation axis inserted into the connecting axis of the second arm, a first upper belt connected to the first upper pulley and the second upper pulley, a third upper pulley disposed at the other end of the first rotation axis, a fourth upper pulley disposed at one end of a connecting axis of the upper arm, and a second upper belt connected to the third upper pulley and the fourth upper pulley.

25. The substrate transfer module of claim 22, wherein the blade driving part includes a first blade pulley disposed in the revolving body and rotated by a driving motor, a second blade pulley disposed at one end of a second rotation axis which inserts the first rotation axis therein and is disposed in the connecting axis of the first arm, a first blade belt connected to the first blade pulley and the second blade pulley, a third blade pulley disposed at the other end of the second rotation axis, a fourth blade pulley disposed at one end of a first rotation axis inserted into the connecting axis of the first arm, a second blade belt connected to the third blade pulley and the fourth blade pulley, a fifth blade pulley disposed at the other end of the third rotation axis, a sixth blade pulley disposed at one end of the connecting axis of the blade, and a third blade belt for connecting the fifth blade pulley to the sixth blade pulley.
